(19) United States
(12) Patent Application Publication
(10) Pub. No.: US 2020/0062243 A1
(43) Pub. Date: Feb. 27, 2020

(54) AUTONOMOUS PARKING IN AN INDOOR PARKING FACILITY

(71) Applicant: Ford Global Technologies, LLC, Dearborn, MI (US)

(72) Inventors: Oswaldo Perez Barrera, Texcoco (MX); Rodrigo Frieventh Cienfuegos, Toluca (MX); David Franco Lopez Rubio, Lerma (MX); Hedy H. Morales Bolaños, Naucalpan (MX)

(73) Assignee: Ford Global Technologies, LLC, Dearborn, MI (US)

(21) Appl. No.: 16/109,475

(22) Filed: Aug. 22, 2018

(51) Int. Cl. B60W 30/06; G05D 1/00

(52) U.S. Cl. CPC B60W 30/06; G05D 1/0248; G05D 1/0088

(57) ABSTRACT

Upon entry to an indoor parking structure, a vehicle may establish communication with a computer system of the parking structure. The vehicle may receive a path to an available parking spot, the path including checkpoints which may broadcast signals. The vehicle may travel the path autonomously to the parking spot. The vehicle further detects the checkpoints and uses their signals to calibrate the vehicle's position.

### FIELD OF THE INVENTION

This invention relates to the implementation of autonomous vehicles.

### BACKGROUND OF THE INVENTION

Autonomous driving relies on GPS tracking as well as conditions along the streets of a route. However, multi-story parking facilities are different environments where GPS signals may not be detectable and detailed routing data might not exist.

In one prior approach (US Patent Application Publication No. 2016/0033963) a building includes movable cameras that detect vehicles within the parking facility, calculates their position and orientation, and transmits instructions to them. However, this approach requires a great deal of infrastructure in the building that may be cost prohibitive.

Accordingly, what is needed is an improved approach for implementing autonomous driving within a parking facility.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of components implementing a system, in accordance with one or more example embodiments of the present disclosure.

FIG. 2 is a schematic block diagram of an example computing device suitable for implementing methods, in accordance with one or more example embodiments of the present disclosure.

FIG. 3 is a process flow diagram of a method for guiding an autonomous vehicle to a parking spot, in accordance with one or more example embodiments of the present disclosure.

FIG. 4A illustrates an example parking facility and path of an autonomous, in accordance with one or more example embodiments of the present disclosure.

FIG. 4B illustrates an example parking facility and path of an autonomous, in accordance with one or more example embodiments of the present disclosure.

FIG. 5 is a process flow diagram of a method for guiding an autonomous vehicle out of a parking facility, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Autonomous driving relies on location (e.g., Global Positioning System) tracking, and on predefined route conditions. However, multi-story car parking structures may include different environments where location signals are not received or are insufficiently accurate for parking vehicles. For example parking structures may not be associated with available inside mapping; and may depend on an altitude coordinates to discern between upper and lower levels. Such may not be function with standard Global Positioning System (GPS) signals, for example.

In an autonomous vehicle environment, a vehicle may be able to park without a human driver. It may therefore be beneficial to provide autonomous vehicle parking for indoor parking structures.

Example embodiments of the present disclosure relate to systems, methods, and devices for enhanced autonomous vehicle parking in indoor parking structures.

In one or more embodiments, when a vehicle arrives in a parking lot, a computer system of the vehicle may establish a communication connection with a computer system associated with the parking lot. For example, a Wi-Fi connection between the vehicle and parking lot computers may be established. The computer system of the parking lot may send signals indicating a speed to be adopted by the vehicle's cruise control or other speed control functions, and may providing parking map information indicating parking spaces and other locations within or near the parking lot. The vehicle inputs provided by the parking lot computer may include coordinate positions of available parking spaces, coordinate positions of parking lot entrances and exits, speed restrictions, time limits, parking fees, and other relevant information.

In one or more embodiments, a vehicle computer system may receive vehicle inputs from the parking lot computer system and may update the vehicle's local coordinate position as the vehicle moves. The vehicle computer may compare the coordinates of the vehicle to the coordinates of any available parking spaces in the parking lot. To synchronize the local coordinates of the vehicle at a given time, the parking lot may include check points, which may be locations, objects, or the like which may be identifiable by the vehicle to determine where the vehicle is within the parking lot.

In one or more embodiments, the vehicle parking may be limited to a single lane direction for safety, and to simply hardware design along with limiting route possibilities. The vehicle may use its own sensors to detect objects and speed as the vehicle moves within the parking lot. The sensors may provide information which the vehicle computer may use to direct the vehicle to a parking space and/or to return the vehicle to a passenger or driver. When the vehicle is parked and/or while the vehicle is moving, the vehicle computer may send messages to a user device (e.g., a user's smartphone) to indicate where the vehicle's position is at a given time, vehicle location, parking status (e.g., time and fees), and the like.

In one or more embodiments, once a free parking place coordinate is indicated by the parking lot computer to the vehicle computer, the free place may be automatically reserved for the vehicle. The vehicle may indicate a selection of a free parking place. For example, if multiple parking spaces are indicated as available, the vehicle computer may select one (e.g., automatically or via a user selection). The vehicle may communicate vehicle information (e.g., license plate, VIN, or the like) to the parking lot computer to indicate the vehicle's presence and a demand for parking space reservations. The vehicle may also communicate payment information before or after parking in an available parking space. When a vehicle reserves a parking space, the parking system may store an indication that the vehicle has reserved the parking space and/or may send an indication to a database to indicate that the vehicle has reserved the parking space.

The autonomous vehicle parking system may be used as an autonomous valet-parking service. A driver may save time when leaving vehicle to be parked autonomously, as there may be no check-in with another human, nor the time spent searching for parking space. Parking lot owners and managers also may benefit from the autonomous vehicle parking system, as parking efficiency may be improved through automation by reducing the time needed for toll operator interaction, reducing congestion while drivers and vehicles search for parking spaces, and the risk of accidents is reduced through improved coordination using a computer-based system. Parking lot location and structure information, which may be subject to security concerns, also may be protected and limited to vehicles which enter a structure for parking.

In one or more embodiments, the autonomous vehicle parking system may not require cameras to detect vehicles and parking spaces. The autonomous vehicle parking system may not need to track each vehicle entering a parking structure to coordinate parking among the vehicles because, for example, the vehicles may be able to perform parking functions based on the information provided by a parking lot structure. The parking structure computer may not need to determine and track vehicle locations while vehicles move within a parking structure, and the parking structure computer may not need to determine driving routes for vehicles to move vehicles to available parking spaces.

The embodiments disclosed herein may allow for enhanced autonomous vehicle parking within indoor structures.

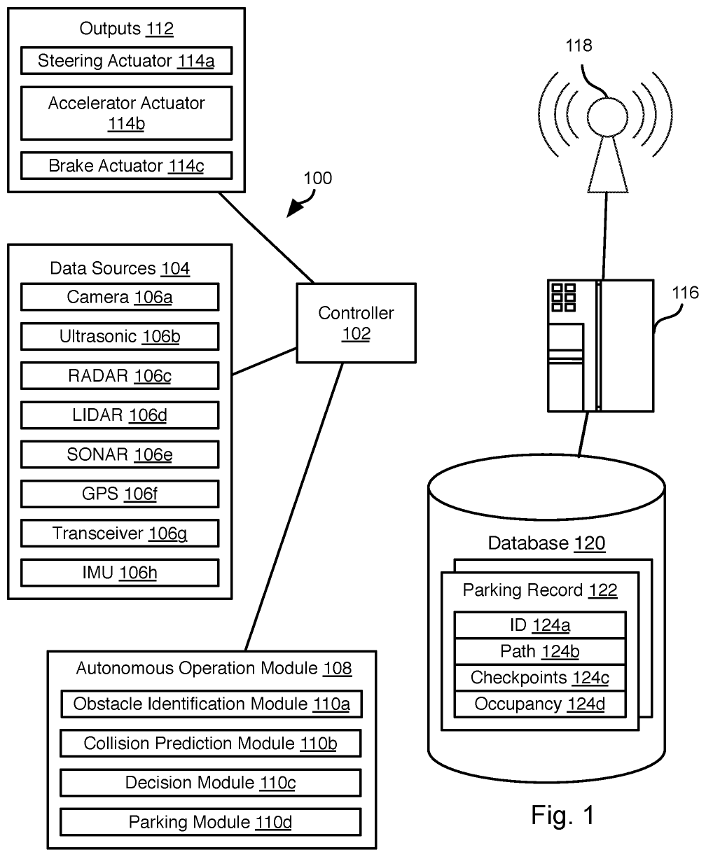

Referring to FIG. 1, the methods disclosed herein may be performed using the illustrated system 100. As discussed in greater detail herein, a controller 102 may be programmed to perform the methods disclosed herein and may also perform other functions performed by a vehicle controller (e.g., electronic control unit (ECU)) or in-vehicle infotainment (IVI) system. The controller 102 may be housed in a vehicle (not shown) having the structures and features of any vehicle known in the art including, wheels, a drive train coupled to the wheels, an engine coupled to the drive train, a steering system, a braking system, and other systems known in the art to be included in a vehicle.

The controller 102 may receive one or more outputs from one or more data sources 104. For example, one or more cameras 106a may be mounted to the vehicle and output image streams to the controller 102. The data sources 104 may include sensors such as an ultrasonic sensor 106b, a RADAR (Radio Detection and Ranging) sensor 106c, a LIDAR (Light Detection and Ranging) sensor 106d, a SONAR (Sound Navigation and Ranging) sensor 106e, and the like.

Other sources 104 of data may include a GPS (global positioning system) receiver 106f and a vehicle-to-vehicle (V2V) and/or vehicle-to-infrastructure (V2I) transceiver 106g. The transceiver 106g may communicate with other vehicles and infrastructure according to a wireless protocol such as DSRC (dedicated short range communications) protocol. The transceiver 106g may communicate with parking structure computers and or database 120 using wireless connections such as Wi-Fi, Bluetooth, peer-to-peer, cellular, or the like.

The data sources 104 may further include an inertial measurement unit (IMU) 106h that facilitates measurement of the vehicle's movement in the absence of GPS coordinates. For example, the IMU 106h may include some or all of gyroscopes, accelerometers, and one or more magnetic compasses to facilitate the determination of the vehicle's orientation and to relate measured acceleration and turning of the vehicle to a distance and direction traveled.

The controller 102 may execute an autonomous operation module 108 that receives the outputs of some or all of the data sources 104. The autonomous operation module 108 may include an obstacle identification module 110a, a collision prediction module 110b, and a decision module 110c. The obstacle identification module 110a analyzes the outputs of some or all of the data sources 104 and identifies potential obstacles, including people, animals, vehicles, buildings, curbs, and other objects and structures. In particular, the obstacle identification module 110a may identify other vehicles in the sensor outputs.

The collision prediction module 110b predicts which obstacles are likely to collide with the vehicle 100 based on its current trajectory or current intended path. The collision prediction module 110b may evaluate the likelihood of collision with objects identified by the obstacle identification module 110a. The decision module 110c may make a decision to stop, accelerate, turn, etc. in order to avoid obstacles. The manner in which the collision prediction module 110b predicts potential collisions and the manner in which the decision module 110c takes action to avoid potential collisions may be according to any method or system known in the art of autonomous vehicles.

In embodiments disclosed herein, the autonomous operation module 108 may perform autonomous navigation to a specified location, autonomous parking, and other automated driving activities known in the art.

The controller 102 may control one or more outputs 112 in order to autonomously drive the vehicle and to coordinate parking according to the methods described hereinbelow. For example, the decision module 110c may control the trajectory of the vehicle by actuating one or more actuators controlling the direction and speed of the vehicle 100. For example, the actuators may include a steering actuator 114a, an accelerator actuator 114b, and a brake actuator 114c. The configuration of the actuators 114a-114c may be according to any implementation of such actuators known in the art of autonomous vehicles.

In some embodiments, the system 100 may coordinate with the computer system 116 of a parking structure (not shown) according to the method disclosed herein. Accordingly, the autonomous operation module 108 may include a parking module 110d that communicates with the computer system 116 of the parking structure and implements other methods as described hereinbelow.

The parking structure may include a wireless transceiver 118 for communicating with the transceiver 106g of the vehicle. Accordingly, the transceiver 118 may communicate according to DSRC or other wireless communication protocol such as BLUETOOTH, WI-FI, a cellular data communication protocol, or the like.

The computer system 116 may host or access a database 120 that includes records 122 for a plurality of parking spots within the parking structure. The record 122 for a parking spot may include such information as an identifier 124a for the parking spot (code and/or two- or three-dimensional coordinate), a path 124b from an entrance of the parking structure to the parking spot, identifiers of one or more checkpoints 124c lying on the path, and an occupancy status 124d (occupied or unoccupied) of the parking spot. Note that the path from the entrance to the parking spot may be different from the path from the parking spot to an exit. Accordingly, the record 122 may also include an exit path from the parking spot to an exit. The parking spot itself may have a corresponding checkpoint. Accordingly, the checkpoints 124c may include a reference to the checkpoint of the parking spot itself and it may be flagged as corresponding to the parking spot or be understood to be such as being the last checkpoint 124c on the path 124b. The checkpoints 124c in the record 122 may be represented as codes that are unique to each checkpoint in the parking structure. Alternatively or additionally, the checkpoints 124c may broadcast two-dimensional or three-dimensional locations of the checkpoints along the path 124b.

The path 124b may be pre-calculated such that the computer system 120 may not be required to have the capacity to model the parking structure or otherwise calculate a path for each vehicle using the parking structure. The path 124b to a parking spot and the checkpoints 124c along it may be determined by a human operator or pre-calculated by the computer system 116 or some other computer system based on a model of the parking structure. Regardless of the means by which they are generated, the path 124b and the checkpoints 124a for a parking spot are loaded into the database 120 prior to entry of a vehicle into the parking structure and do not need to be calculated each time a parking spot is allocated to a vehicle.

In some embodiments, a single circuit or path through the parking structure is defined and all paths 124b are constrained to follow at portion of this single path to a given parking spot. Accordingly, in such embodiments, the path 124b may be the same for each parking spot with the checkpoint for a given parking spot being used to determine when to exit the single path 124b. In some embodiments, vehicles may be directed to proceed in a same direction along the circuit to avoid collisions.

The checkpoints in the parking structure may be beacons transmitting wireless signals. The checkpoints may transmit using any wireless protocol known in the art, such as a short range wireless communication protocol such as DSRC, BLUETOOTH, BLUETOOTH LOW ENERGY (BLE), ANT+, or the like. The controller 102 may detect signals from the checkpoints using the transceiver 106g or a separate transceiver.

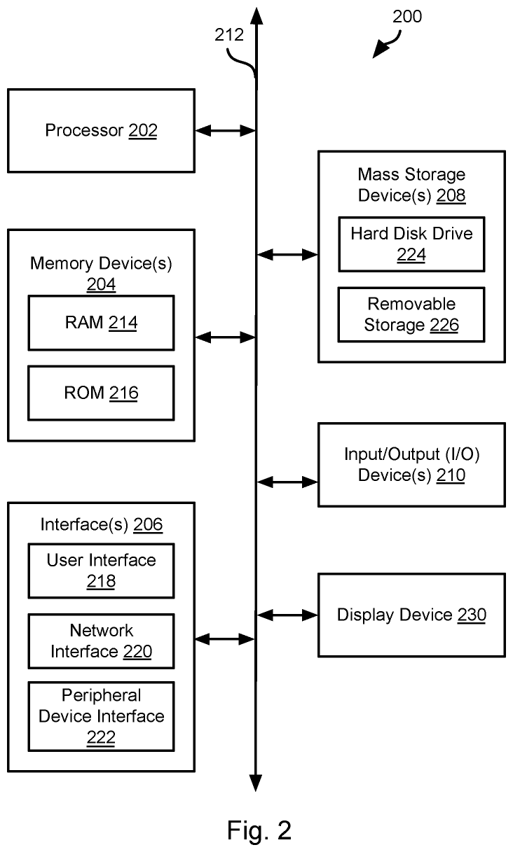

FIG. 2 is a block diagram illustrating an example computing device 200. Computing device 200 may be used to perform various procedures, such as those discussed herein. The controller 102 and computer system 116 may have some or all of the attributes of the computing device 200.

Computing device 200 includes one or more processor(s) 202, one or more memory device(s) 204, one or more interface(s) 206, one or more mass storage device(s) 208, one or more input/output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

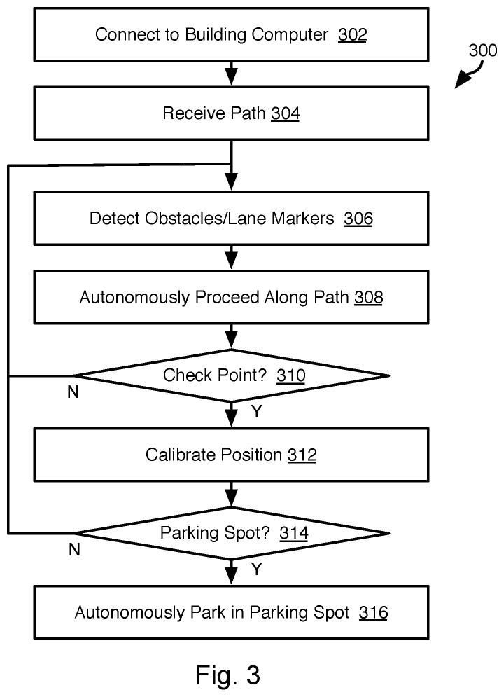

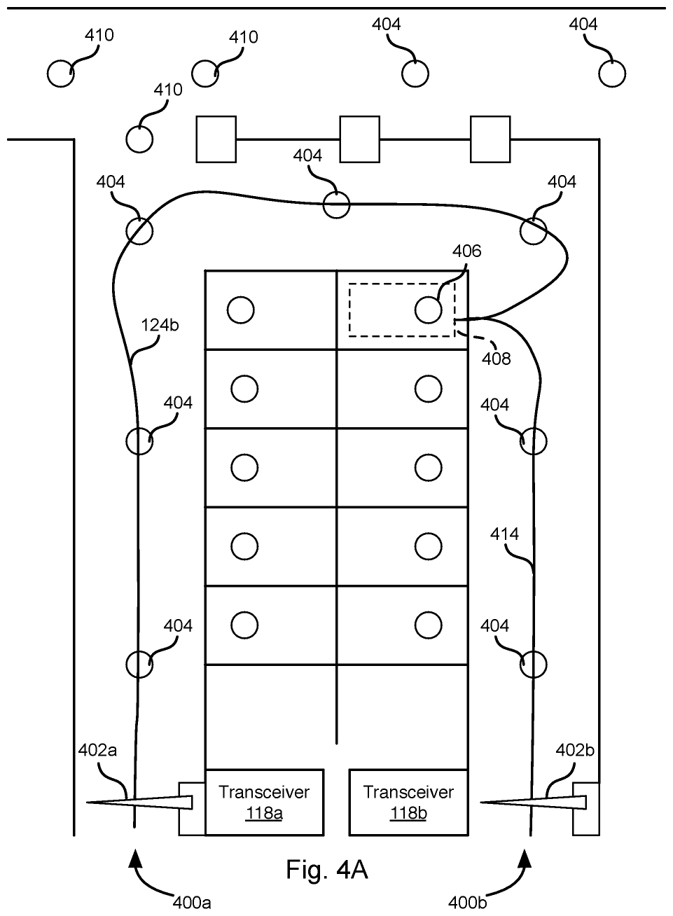

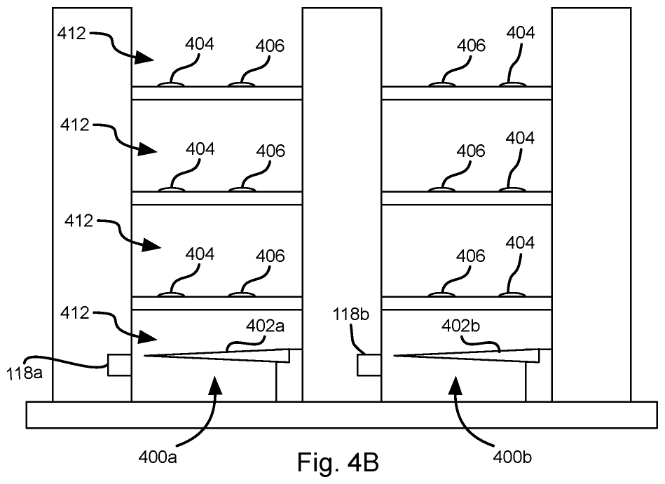

Referring to FIG. 3, the illustrated method 300 may be executed by the controller 102 in cooperation with the computer system 116 of a parking structure. The execution of the method 300 is described with respect to the diagrams of FIGS. 4A and 4B.

The method 300 may include connecting 302 to the computer system 116. For example, a transceiver 118a may be located at the entrance 400a of the parking structure as shown in FIG. 4A, or in some other location in or near the parking structure. Accordingly, a vehicle passing through the entrance 400a may detect signals from this transceiver 118a and connect 302 to it. The computer system 116 of the vehicle may connect to transceiver 118a of the parking structure using Wi-Fi, Bluetooth, cellular, or other wireless connection methods.

In some embodiments, the computer system 116 may control a gate 402a at the entrance 400a. Accordingly, the computer system 116 may maintain the gate 402a closed until the connection 302 is established and communication according to the method 300 has occurred. In other embodiments, the controller 102 may be programmed to wait at the entrance 400a of a parking structure until a connection is established and information is received from the computer system 116 of the parking structure according to the method 300. In some embodiments, another transceiver 118b and gate 402b may be located at the exit 400b of the parking structure. The transceivers 118a, 118b may have some or all of the attributes of the transceiver 118.

In some embodiments, a vehicle may enter the entrance 400a. A human driver or controller 102 may also process electronic payment for parking services prior to autonomous parking according to the subsequent steps described below.

The method 300 may then include receiving 304 a path from the computer system 116 over the connection. In particular, the computer system 116 may select a record 122 for a parking spot that is recorded as unoccupied in the occupancy 124d. In some embodiments, the computer system 116 selects the closest unoccupied parking spot to the entrance 400a. The computer system 116 then returns the pre-calculated path 124b to the selected parking spot to the controller 102. The computer system 116 may also return references 124c to the checkpoints along the path 124b. For example, where each checkpoint broadcasts an identifier, the computer system 116 may transmit a mapping that maps the two- or three-dimensional coordinates of each checkpoint 124c to its broadcast identifier. Step 304 may further include transmitting a speed limit to the controller 102 that limits how fast the controller 102 causes the vehicle to travel within the parking structure.

The path and checkpoint locations may be specified using a local coordinate system. Accordingly, steps 302-304 may include calibrating the coordinate system of the vehicle to this local coordinate system, such as by the computer system 116 transmitting the position of the entrance according to the local coordinate system to the controller 102 while the vehicle is at the entrance, e.g. stopped at the gate 402a.

Following transmission of the information from step 304, the computer system 116 may instruct the controller 102 to proceed along the path 124b and may open the gate 402a. The computer system 116 may also update the record 122 for the selected parking spot such that the occupancy field 124d indicates that the selected parking spot is occupied. As part of steps 302-304, the vehicle may transmit an identifier to the computer system 116, which then associates this identifier with the record 122 for the selected parking spot.

The controller 102 may then perform autonomous navigation functions such as detecting 306 obstacles, lane markings, walls, columns, and other structures within the parking structure. The controller 102 may autonomously cause the vehicle to proceed 308 along the path 124b while performing obstacle avoidance and maintaining the vehicle within a lane defined by lane markings, walls, columns, and other structures within the parking structure. Autonomously proceeding 308 may include using the IMU 106h and the other sensors 106a-106d to detect movement of the vehicle and estimate the path actually followed by the vehicle and to control the outputs 112 effective to cause the actual path to conform to follow the received path 124b subject to limits of control precision and deviations for obstacle avoidance.

During traversal of the path 124b, the method 300 may further include evaluating 310 whether checkpoints have been detected. For example, as shown in FIG. 4A, checkpoints 404 may be distributed along the path 124b. In response to detecting a checkpoint 404, the method 300 may include calibrating 312 the position of the vehicle. As the vehicle proceeds autonomously at step 308, errors in the estimated position and orientation of the vehicle may accumulate. Accordingly, upon detecting a checkpoint 404, the vehicle may compare its current position to the position indicated by the checkpoint 404. For example, the controller 102 may receive a signal from a checkpoint 404, obtain an identifier from the signal, and determine the coordinates of the checkpoint 404 from the mapping received from the computer system 116. In other embodiments, the signal from the checkpoint 404 may include the coordinates of the checkpoint 404.

The checkpoint location may be related to the position of the vehicle using various approaches. In a simple approach, the position of the vehicle may be assumed to be the checkpoint location, either directly or by applying a fixed correction. This may be suitable where the range of the checkpoints is low such that detection of a signal from a checkpoint may be assumed to indicate co-location.

In other approaches, a direction to the checkpoint (such as determined using a directional antenna) and the strength of the signal from a checkpoint may be used to estimate the relative position of the vehicle to the checkpoint. The checkpoint location may then be adjusted according to the relative position and this adjusted location may be used as the current location of the vehicle.

In other embodiments, checkpoints 404 may be arranged in clusters such that multiple checkpoints may be detected simultaneously. The vehicle's position may then be determined from the locations of these checkpoints using triangulation.

The vehicle may then continue along the route according to steps 306 and 308 until the controller 102 detects 314 that it has arrived at the parking spot at the end of the received path 124b. The controller 102 may detect 314 arrival by determining that its current estimated position according to steps 308 and/or 312 is within some threshold proximity to the location of the parking spot indicated by the path 124b. Detecting 314 arrival may additionally or alternatively include detecting a signal from a checkpoint 406 marking the parking spot 408.

Upon detecting arrival, the controller 102 may then autonomously park 316 in the parking spot. This may include detecting boundaries of the parking spot according to painted lines or other visible structures, detecting any vehicles parked on either side of the parking spot, and detecting columns, walls, or other structures of the parking structure around the parking spot. The controller 102 may then cause the vehicle to navigate (e.g., may direct the vehicle) into the parking spot while avoiding collisions with detected objects using any approach for autonomous parking as known in the art.

Referring specifically to FIG. 4A, the checkpoints 404 may be distributed throughout the parking structure separated by a maximum distance such that they may facilitate autonomous navigation by vehicles. Where a path through the parking structure is straight and provides little room for deviation, the checkpoints 404 may be more widely spaced. Checkpoints 404 may be placed at turns, such as at the apex of turns and possibly at the entrance and exit of turns as well. Checkpoints 410 may be placed at all entrances of an intersection in order to provide guidance and help avoid wrong turns. For example, upon reaching a checkpoint 404 at an intersection, the controller 102 may determine which direction to turn according to the path 124b. For example, the path 124b may include instruction on the order of: turn left (or right) upon detecting checkpoint X.

Referring specifically to FIG. 4B, the parking structure may have multiple levels 412, each of which may be marked with checkpoints 404, 406, 410 in the manner shown in FIG. 4A. Accordingly, the checkpoints 404, 406, 410 may be associated with a three-dimensional location in such embodiments, such as a two-dimensional coordinate with a level number or a two-dimensional coordinate with an elevation. The path 124b to a parking spot may therefore traverse checkpoints 404, 406, 410 on multiple levels 412 in order to arrive at a specified parking spot 408.

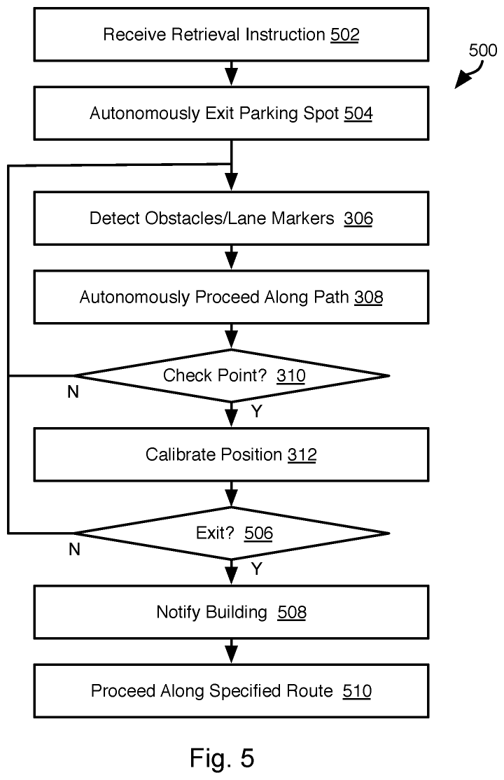

Referring to FIG. 5, the illustrated method 500 may be executed by the controller 102 to autonomously drive out of the parking structure after parking according to the method 300.

The method 500 may include receiving 502 a retrieval instruction. This instruction may be received by the controller 102 by various modalities. For example, if the controller 102 has available a cellular data communication connection, the instruction may be received over that connection, such as from a mobile device of a user requesting retrieval of the vehicle.

In some embodiments, the parking structure may facilitate transmission of retrieval instructions inasmuch as the interior of the parking structure is not accessible from signal sources outside of the parking structure. For example, the retrieval instruction including a vehicle identifier may be transmitted to the computer system 116, which then rebroadcasts the retrieval instruction within the parking structure using a transceiver within range of the vehicle that is a target of the retrieval instruction as determined from the records 122 that indicate where the vehicle corresponding to that vehicle identifier is parked.

The controller 102 may then cause the vehicle to autonomously exit 504 the parking spot, e.g. back out while performing obstacle detection and avoidance. The vehicle may then follow the exit path 414 provided by the computer system 116, which may be the same as or different from the path 124b traversed when entering. Traversing the exit path 414 may include performing steps 306-312 as described above with respect to FIG. 3.

The method 500 may include evaluating 506 whether the exit is detected. This may include detecting reaching an end of the exit path 414, detecting the transceiver 118b at the exit (or the same transceiver 118a as at the entrance), detecting a checkpoint 404 at the exit, detecting an exit sign with the camera 106a, or some other means.

Upon reaching the exit, the controller 102 may notify 508 the computer system 116 that it is exiting, such as by establishing a connection with the transceiver 118b and transmitting the notification over the connection. The connection may include an identifier of the vehicle and/or an identifier of the parking spot exited at step 504. In response to the notification 508, the computer system 116 may then update the occupancy 124d of the record 122 associated with the identifier of the vehicle or the identifier of the parking spot to indicate that it is no longer occupied. The computer system 116 may also open an exit gate 402b in response to the notification, allowing the vehicle to exit the parking structure. The vehicle may then wait for a user to enter the vehicle or may autonomously proceed 510 to a destination or along a route specified in the instruction of step 502 or provided previously to the controller 102.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer usable medium. Such software, when executed in one or more data processing devices, causes a device to operate as described herein.

Some embodiments may be used in various other devices, systems, and/or networks.

Example 1 may be a method comprising, by a controller of a vehicle: determining an indication of a path associated with the vehicle and a parking spot in the parking structure, the indication received from a computer system associated with a parking structure; determining one or more checkpoints associated with the path; and autonomously directing the vehicle to the parking spot based at least in part on the one or more checkpoints and the path.

Example 2 may include the method of example 1 and/or some other example herein, wherein the path is a three dimensional path traversing multiple levels of a parking structure.

Example 3 may include the method of example 1 and/or some other example herein, further comprising calibrating the position of the vehicle according to a checkpoint by receiving an identifier associated with the checkpoint.

Example 4 may include the method of example 3 and/or some other example herein, wherein the identifier is associated with a three-dimensional location in the parking structure, and wherein calibrating the position of the vehicle comprises calibrating based at least in part on the three-dimensional location.

Example 5 may include the method of example 1 and/or some other example herein,

wherein autonomously directing the vehicle to the parking spot comprises the controller of the vehicle: receiving an output of at least one of a camera, a light detection and ranging (LIDAR) sensor, and a radio detection and ranging (RADAR) sensor; and directing the vehicle through the parking structure based at least in part on the output.

Example 6 may include the method of example 1 and/or some other example herein,

wherein autonomously directing the vehicle to the parking spot comprises the controller of the vehicle: detecting an obstacle associated with the path; and directing the vehicle to the parking spot based at least in part on the obstacle.

Example 7 may include the method of example 1 and/or some other example herein, further comprising causing to send, by controller of the vehicle, an indication of the vehicle.

Example 8 may include the method of example 1 and/or some other example herein, further comprising causing to send, by controller of the vehicle, an indication that the vehicle has selected the parking spot.

Example 9 may include the method of example 1 and/or some other example herein, further comprising receiving, from the computer system, a speed from the computer system, wherein autonomously directing the vehicle to the parking spot along the path comprises the controller of the vehicle causing the vehicle to drive at or below the speed.

Example 10 may include the method of example 1 and/or some other example herein, further comprising: determining an exit path from the parking spot, wherein the exit path is different than the path; autonomously directing the vehicle from the parking spot based at least in part on the exit path.

Example 11 may include a system comprising: a plurality of wireless checkpoints distributed throughout a multi-level parking structure, a checkpoint of the plurality of wireless checkpoints broadcasting a signal indicating a three-dimensional position of the checkpoint; a transceiver; and a computer system including one or more processing devices and one or more memory devices operably coupled to the one or more processing devices, the one or more memory devices storing executable code effective to cause the one or more processing devices to: determine, at the transceiver, an indication of a presence of a vehicle; determine, based at least in part on the indication, that the vehicle is present; and cause to transmit, to the vehicle, an indication of a path associated with the vehicle and a parking spot within the parking structure, wherein the path traverses the checkpoint.

Example 12 may include the system of example 11 and/or some other example herein, wherein the path is a three dimensional path traversing multiple levels of the multi-level parking structure.

Example 13 may include the system of example 11 and/or some other example herein, wherein the checkpoint is a first checkpoint, wherein the signal is a first signal, wherein plurality of wireless checkpoints comprises a second checkpoint broadcasting a second signal indicating a three-dimensional position of the second checkpoint, and wherein the path traverses the second checkpoint.

Example 14 may include the system of example 11 and/or some other example herein, wherein the signal comprises an indication of an identifier uniquely associated with the checkpoint.

Example 15 may include the system of example 11 and/or some other example herein, wherein the executable code is further effective to cause the one or more processing devices to, in response to determining that the vehicle is present: determine that the parking spot is available; and determine the path to the parking spot.

Example 16 may include the non-transitory computer-readable medium of example 15 and/or some other example herein, wherein the executable code is further effective to cause the one or more processing devices to, in response to determining that the vehicle is present, update a database to indicate that the parking spot is unavailable.

Example 17 may include the system of example 11 and/or some other example herein, wherein the executable code is further effective to cause the one or more processing devices to receive an indication that the vehicle has selected the parking spot.

Example 18 may include the system of example 11 and/or some other example herein, wherein the executable code is further effective to cause the one or more processing devices to transmit an indication of a speed limit to the vehicle.

Example 19 may include the system of example 11 and/or some other example herein, wherein the executable code is further effective to cause the one or more processing devices to transmit an indication of an exit path from the parking spot, wherein the exit path is different than the path.

Example 20 may include a device associated with a vehicle, the device comprising memory and processing circuitry configured to: determine an indication of a path associated with the vehicle and a parking spot in a parking structure; determine one or more checkpoints associated with the path; and autonomously direct the vehicle to the parking spot based at least in part on the one or more checkpoints and the path.

Example 21 may include an apparatus comprising means for: performing the method of any of examples 1-10.

Example 22 may include one or more non-transitory computer-readable media comprising instructions to cause an electronic device, upon execution of the instructions by one or more processors of the electronic device, to perform one or more elements of a method described in or related to any of examples 1-10, or any other method or process described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

What is claimed is:

1. A method comprising, by a controller of a vehicle:
determining an indication of a path associated with the vehicle and a parking spot in the parking structure, the indication received from a computer system associated with a parking structure;
determining one or more checkpoints associated with the path; and
autonomously directing the vehicle to the parking spot based at least in part on the one or more checkpoints and the path.

2. The method of claim 1, wherein the path is a three dimensional path traversing multiple levels of a parking structure.

3. The method of claim 1, further comprising calibrating the position of the vehicle according to a checkpoint by receiving an identifier associated with the checkpoint.

4. The method of claim 3, wherein the identifier is associated with a three-dimensional location in the parking structure, and wherein calibrating the position of the vehicle comprises calibrating based at least in part on the three-dimensional location.

5. The method of claim 1, wherein autonomously directing the vehicle to the parking spot comprises the controller of the vehicle:
receiving an output of at least one of a camera, a light detection and ranging (LIDAR) sensor, and a radio detection and ranging (RADAR) sensor; and
directing the vehicle through the parking structure based at least in part on the output.

6. The method of claim 1, wherein autonomously directing the vehicle to the parking spot comprises the controller of the vehicle:
detecting an obstacle associated with the path; and
directing the vehicle to the parking spot based at least in part on the obstacle.

7. The method of claim 1, further comprising causing to send, by controller of the vehicle, an indication of the vehicle.

8. The method of claim 1, further comprising causing to send, by controller of the vehicle, an indication that the vehicle has selected the parking spot.

9. The method of claim 1, further comprising receiving, from the computer system, a speed from the computer system, wherein autonomously directing the vehicle to the parking spot along the path comprises the controller of the vehicle causing the vehicle to drive at or below the speed.

10. The method of claim 1, further comprising:
determining an exit path from the parking spot, wherein the exit path is different than the path;
autonomously directing the vehicle from the parking spot based at least in part on the exit path.

11. A system comprising:
a plurality of wireless checkpoints distributed throughout a multi-level parking structure, a checkpoint of the plurality of wireless checkpoints broadcasting a signal indicating a three-dimensional position of the checkpoint;
a transceiver; and
a computer system including one or more processing devices and one or more memory devices operably coupled to the one or more processing devices, the one or more memory devices storing executable code effective to cause the one or more processing devices to:
determine, at the transceiver, an indication of a presence of a vehicle;
determine, based at least in part on the indication, that the vehicle is present; and
cause to transmit, to the vehicle, an indication of a path associated with the vehicle and a parking spot within the parking structure, wherein the path traverses the checkpoint.

12. The system of claim 11, wherein the path is a three dimensional path traversing multiple levels of the multi-level parking structure.

13. The system of claim 11, wherein the checkpoint is a first checkpoint, wherein the signal is a first signal, wherein plurality of wireless checkpoints comprises a second checkpoint broadcasting a second signal indicating a three-dimensional position of the second checkpoint, and wherein the path traverses the second checkpoint.

14. The system of claim 11, wherein the signal comprises an indication of an identifier uniquely associated with the checkpoint.

15. The system of claim 11, wherein the executable code is further effective to cause the one or more processing devices to, in response to determining that the vehicle is present:
determine that the parking spot is available; and
determine the path to the parking spot.

16. The system of claim 15, wherein the executable code is further effective to cause the one or more processing devices to, in response to determining that the vehicle is present, update a database to indicate that the parking spot is unavailable.

17. The system of claim 11, wherein the executable code is further effective to cause the one or more processing devices to receive an indication that the vehicle has selected the parking spot.

18. The system of claim 11, wherein the executable code is further effective to cause the one or more processing devices to transmit an indication of a speed limit to the vehicle.

19. The system of claim 11, wherein the executable code is further effective to cause the one or more processing devices to transmit an indication of an exit path from the parking spot, wherein the exit path is different than the path.

20. A device associated with a vehicle, the device comprising memory and processing circuitry configured to:
determine an indication of a path associated with the vehicle and a parking spot in a parking structure;
determine one or more checkpoints associated with the path; and
autonomously direct the vehicle to the parking spot based at least in part on the one or more checkpoints and the path.
